(19) United States
(12) Patent Application Publication
(10) Pub. No.: US 2025/0338981 A1
(43) Pub. Date: Nov. 6, 2025

(54) EXPANDABLE CORNER CONNECTOR FOR FRAMES AND MODULAR STRUCTURES

(71) Applicant: Thái Long Quân, Dong Ha City (VN)

(72) Inventor: Thái Long Quân, Dong Ha City (VN)

(21) Appl. No.: 19/196,972

(22) Filed: May 2, 2025

Related U.S. Application Data
(60) Provisional application No. 63/642,657, filed on May 4, 2024.

(51) Int. Cl. A47G 1/10; F16B 2/04

(52) U.S. Cl. CPC A47G 1/102; F16B 2/04

(57) ABSTRACT

The present disclosure relates to a corner connector for frames and modular structures, designed for seamless and reversible frame assembly. The corner connector comprises an expandable body and a central channel to house a screw. Upon screw tightening, the connector expands against the frame bars to ensure a secure corner joint. The corner connector is made from materials such as plastics, metals, and composites, for durability and flexibility for repeated use. Internally threaded, the central channel pairs with a complementary threaded screw, facilitating a strong interlock with frame bars that feature mating semi-circular notches. The body's textured exterior enhances grip, ensuring a stable, aesthetic finish.

### CROSS-REFERENCE TO RELATED APPLICATIONS

This application claims the benefit of U.S. Provisional Patent Application No: 63/642,657, filed on May 4, 2024, which is hereby incorporated by reference herein in its entirety.

### TECHNICAL FIELD

The present invention relates to the field of frames and modular structures, and more specifically, to a mechanical connector system for assembling and disassembling corners of frames and modular structures. In particular, the invention pertains to an expandable corner connector that facilitates the quick, reliable, and reversible construction of frame corners using a mechanical fastener, and without the need for specialized tools or permanent fixing methods such as adhesives or nails. The corner connect may also be used in modular structures, including but not limited to tables, bookshelves, and furniture assemblies requiring reversible corner joining.

### BACKGROUND OF THE INVENTION

Picture frames have traditionally been assembled using various methods that often require permanent fastening solutions, such as nails, screws, staples, or adhesives. While effective in creating a stable structure, these methods present several limitations. For instance, the use of adhesives does not allow for the disassembly of the frame without damage, and the use of nails or screws requires holes to be made in the frame material, which can weaken the structural integrity and limit the reusability of the frame components. These methods also mar the aesthetic appearance of the frame.

In addition, the assembly and disassembly process of traditional picture frames require time and effort, particularly when aligning the frame components at precise angles to form a perfect corner. This process can be cumbersome and may require skilled labor to achieve the desired aesthetic and functional results. Furthermore, the storage and transportation of pre-assembled frames can be inconvenient due to their increased size and the risk of damage, necessitating a more efficient solution that allows frames to be disassembled and reassembled without compromising the integrity and appearance of the frame.

The prior art includes various types of mechanical fasteners and connectors intended to address these issues. However, many of these existing solutions still lack the ability to offer a combination of easy assembly and disassembly, a strong and durable joint, and an aesthetically pleasing finish without additional covering or cosmetic work. Some systems that do allow for disassembly tend to require specific tools or are not intuitive to use, which can be a barrier for non-professional users. Additionally, many prior art solutions fail to provide a secure and reliable connection that can withstand repeated assembly and disassembly cycles without damaging the frame components or compromising the structural integrity of the frame.

There exists, therefore, a need for an improved corner connector for frames that offers a balance of strength, ease of use, aesthetic appeal, and the flexibility to be easily assembled and disassembled. Such a connector should ideally provide a secure joint without damaging the frame material, allow for the compact storage and transport of disassembled frames, and be reusable, thereby offering cost savings and environmental benefits. The connector should also be easy to manufacture and use with a minimum number of parts.

### SUMMARY OF THE INVENTION

In light of the requirements mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments of the present invention disclose an expandable corner connector for frames and modular structures.

According to an embodiment of the present invention, the expandable corner connector for joining first and second frame bars at a corner of a frame comprises: a body made of a durable and flexible material, and a central channel configured to accommodate a fastening screw. The body is configured to be positioned within corresponding notches in the first and second frame bars. Upon insertion and tightening of the screw within the central channel, the body expands outward against the frame bars to secure the connection between the frame bars.

According to an embodiment of the present invention, the fastening screw comprises a threaded shaft that mates with corresponding internal threads of the central channel.

According to an embodiment of the present invention, the screw further includes a head configured to engage with a driving tool to facilitate rotation and tightening of the screw.

According to an embodiment of the present invention, the corner connector's body material is selected from the group consisting of plastics, metals, and composites.

According to an embodiment of the present invention, the exterior surface of the body is textured to enhance frictional engagement with the frame bars.

According to an embodiment of the present invention, the corner connector's body is shaped to fit within corresponding notches in the frame bars, wherein the notches are created by cutting and milling.

According to an embodiment of the present invention, the frame bars are made of a material selected from wood, metal, or composite materials, and the notches are semi-circular to match the contour of the corner connector.

According to an embodiment of the present invention, the notches in the frame bars are of any complementary shape configured to receive the connector body and facilitate expansion-based locking.

According to an embodiment of the present invention, the body of the corner connector comprises a longitudinal slit extending from the central channel to the exterior surface.

This summary is provided merely for the purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 is a perspective view of an expandable corner connector for frames according to the embodiments of the present disclosure.

FIG. 2 is a top view of the expandable corner connector for frames according to the embodiments of the present disclosure.

FIG. 3 is a bottom view of the expandable corner connector for frames according to the embodiments of the present disclosure.

FIG. 4 is a front view of the expandable corner connector for frames according to the embodiments of the present disclosure.

FIG. 5 is a left view of the expandable corner connector for frames according to the embodiments of the present disclosure.

FIG. 6 is a perspective view of the expandable corner connector with frames according to the embodiments of the present disclosure.

FIG. 7 is another perspective view of the expandable corner connector with frames according to the embodiments of the present disclosure.

FIG. 8 is another perspective view of the expandable corner connector with frames according to the embodiments of the present disclosure.

FIG. 9 is another perspective view of the expandable corner connector with frames according to the embodiments of the present disclosure.

### DETAILED DESCRIPTION

In the following description of the embodiments of the invention, reference is made to the accompanying drawings that form a part hereof, and which are shown by way of illustration of specific embodiments in which the invention may be practiced. These embodiments are described in sufficient detail to enable those skilled in the art to practice the invention, and it is to be understood that other embodiments may be utilized and that changes may be made without departing from the scope of the present invention.

The specification may refer to “an”, “one” or “some” embodiment(s) in several locations. This does not necessarily imply that each such reference is to the same embodiment(s), or that the feature only applies to a single embodiment. Single feature of different embodiments may also be combined to provide other embodiments.

As used herein, the singular forms “a”, “an” and “the” are intended to include the plural forms as well unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries should be interpreted as having a meaning that is consistent with their meaning in the context of the relevant art and will not be interpreted in an idealized or overly formal sense unless expressly so defined herein.

The utility of the devices described herein will be explained further in detail in the following sections of this document referring to the figures. Specific terms used herein do not restrict the scope of the present disclosure.

Embodiments of the present invention disclose an expandable corner connector for frames and modular structures.

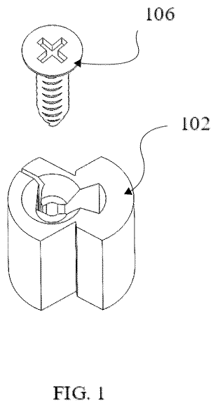

FIG. 1 is a perspective view of the expandable corner connector 102 for the frames 104A-B according to the embodiments of the present disclosure. According to an embodiment of the present invention, the corner connector 102 for joining the two frame bars 104A-B at a corner of a frame comprises a body made of a durable and flexible material and a central channel 108 configured to accommodate a screw 106. The body of the corner connector 102 is configured to be positioned within corresponding notches 112A-B in the frame bars 104A-B. Upon insertion and tightening of the screw 106 within the central channel 108, the body of the corner connector 102 expands outward against the frame bars 104A-B, thereby securing the connection between the frame bars 104A-B.

According to an embodiment of the present invention, the material of the body is selected from the group consisting of plastics, metals and composites to provide sufficient flexibility and durability for multiple assembly and disassembly cycles.

According to an embodiment of the present invention, the central channel 108 comprises an internal threading to mate with corresponding threading on the screw 106. The screw 106 features a head and shaft, wherein the shaft is dimensioned to engage with corresponding threads lining the central channel 108. In some embodiments, the central channel may be non-threaded. A self-tapping screw or compression mechanism may expand the connector body to secure the frame bars.

In the FIG. 1, the frame bar 104A comprises a concave semicircular notch 112A at one end and the frame bar 104B comprises a corresponding notch 112B configured to align with the notch 112A of the frame bar 104A. The notches 112A-B are created by cutting and milling.

According to an embodiment of the present invention, the components are configured to fit together to form the corner connector 102 connection for the frame. The notch 112A-B in each frame bar 104A-B receives a portion of the corner connector 102, and the screw 106 is used to tighten and secure the connection.

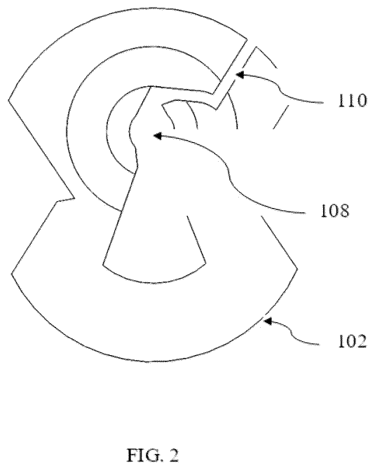

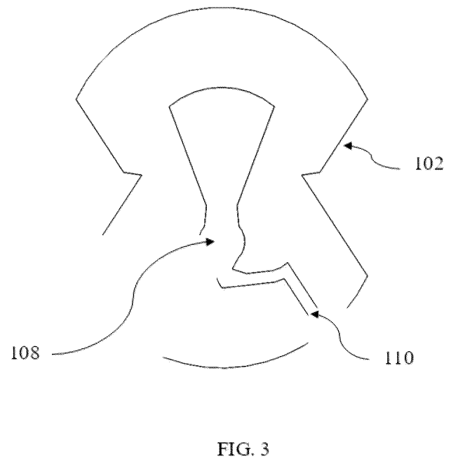

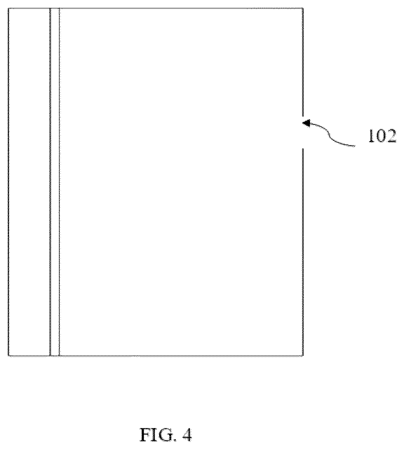

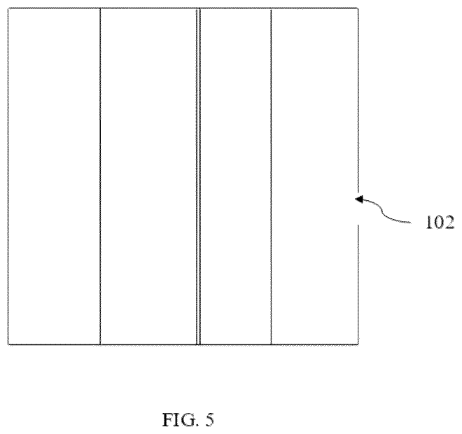

According to an embodiment of the present invention, the body of the corner connector 102 comprises a longitudinal slit 110 extending from the central channel 108 to the exterior surface. This longitudinal slit 110 allows the body of the corner connector 102 to radially expand outward when the screw 106 is tightened within the central channel 108, thereby enabling the body to firmly engage with the corresponding notches 112A-B in the frame bars 104A-B. Further, the exterior surface of the body of the corner connector 102 is textured to increase frictional engagement with the frame bars 104A-B. In some embodiments, the connector body may have a textured or smooth exterior surface, depending on the frictional properties of the frame materials. FIGS. 2, 3, 4, and 5 illustrate top, bottom, front, and left views, respectively, of the corner connector 102 for frames according to the embodiments of the present disclosure.

In one embodiment, a picture frame assembly is disclosed. The picture frame assembly comprises a first frame bar (e.g., 104A) having a first notch (eg., 112A), a second frame bar (e.g., 104B) having a second notch (e.g., 112B), wherein the first notch and the second notch are configured to align to form a corner; and a corner connector 102 for joining the first and second components at the corner, the corner connector 102 comprising: a body (part of 102) comprising a first end and a second end; a central channel 108 extending longitudinally through the body from the first end to the second end, the central channel 108 having an internal thread; wherein the body (part of 102) is configured to be positioned within the corresponding notches or receptacles (e.g., notches 112A-B) in the first and second components (e.g., frame bars 104A-B); a screw 106 having a head and a threaded shaft, the threaded shaft configured to engage with the internal thread of the central channel 108; wherein, upon insertion and tightening of the screw 106 within the central channel 108, the body (part of 102) is configured to expand outward against the first and second components (e.g., frame bars 104A-B), thereby securing the connection between the first and second components (e.g., frame bars 104A-B). In some embodiments, the modular structure assembly, wherein the central channel 108 is non-threaded, and expansion of the body (part of 102) is achieved by a self-tapping screw, compression, or frictional engagement.

In one embodiment, a modular structure assembly is disclosed. The modular structure assembly comprises first and second components (e.g., frame bars 104A-B) having corresponding notches or receptacles (e.g., notches 112A-B) configured to align to form a corner; and a corner connector 102 for joining the first and second components at the corner, the corner connector 102 comprising: a body (part of 102) comprising a first end and a second end; a central channel 108 extending longitudinally through the body from the first end to the second end, the central channel 108 having an internal thread; wherein the body (part of 102) is configured to be positioned within the corresponding notches or receptacles (e.g., notches 112A-B) in the first and second components (e.g., frame bars 104A-B); a screw 106 having a head and a threaded shaft, the threaded shaft configured to engage with the internal thread of the central channel 108; wherein, upon insertion and tightening of the screw 106 within the central channel 108, the body (part of 102) is configured to expand outward against the first and second components (e.g., frame bars 104A-B), thereby securing the connection between the first and second components (e.g., frame bars 104A-B). In some embodiments, the modular structure assembly, wherein the central channel 108 is non-threaded, and expansion of the body (part of 102) is achieved by a self-tapping screw, compression, or frictional engagement.

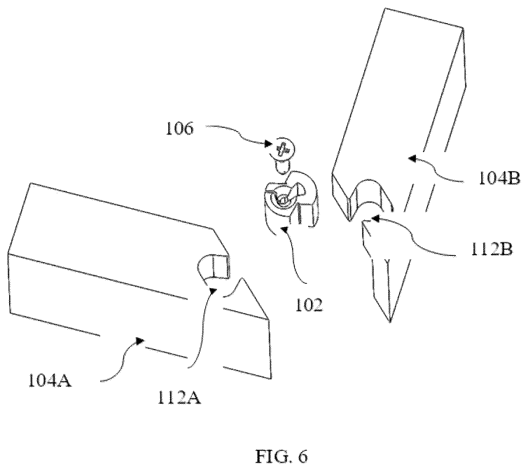

FIG. 6 is a perspective view of the corner connector 102 with the frames 104A-B according to the embodiments of the present disclosure. More specifically, FIG. 6 illustrates the individual components of the frames 104A-B and corner connector 102 before assembly. It depicts a horizontal frame bar 104A at the bottom, with a semi-circular notch 112A at its right end, and a vertical frame bar 104B partially seen at the top right, illustrating where its semi-circular notch 112B will connect to complete the corner. The screw 106 is shown adjacent to the corner connector 102, ready to be inserted.

In some embodiments, the notches in the frame bars can be of any complementary shape configured to receive the connector body and facilitate expansion-based locking.

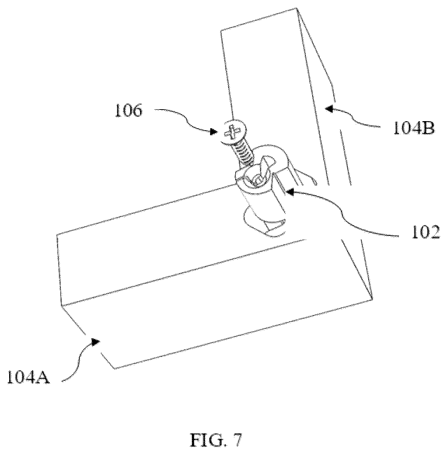

FIG. 7 is another perspective view of the corner connector 102 with the frames 104A-B according to the embodiments of the present disclosure. FIG. 7 shows a partially assembled corner connector 102, wherein the corner connector 102 is positioned within the notches 112A-B of the frame bars 104A-B, and the screw 106 is aligned to be inserted into the corner connector 102.

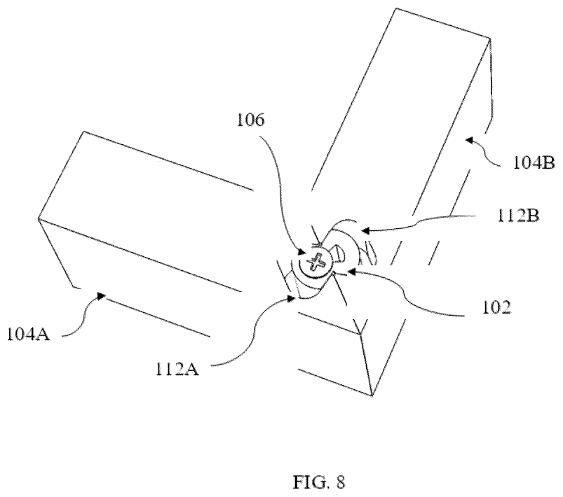

FIG. 8 is another perspective view of the corner connector 102 with the frames 104A-B according to the embodiments of the present disclosure. M ore particularly, it illustrates a fully assembled corner connector 102 for frames 104A-B, wherein the frame bars 104A-B are joined at a precise angle and the corner connector 102 is secured in place with the screw 106. The lower frame bar 104A extends horizontally, and the vertical frame bar 104B completes the corner. The corner connector 102 is positioned within the notches 112A-B of the frame bars 104A-B, with the screw 102 fastened inside the central channel 108 of the corner connector 102 to tightly clamp the frame bars 104A-B together. The assembled components provide a clean, precise corner, facilitating a strong and stable connection.

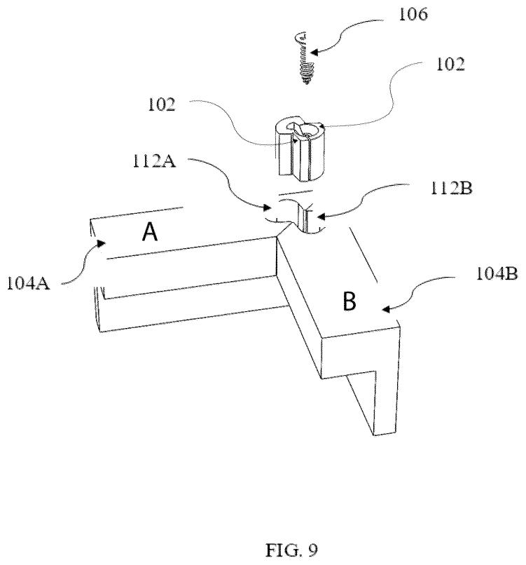

FIG. 9 is another perspective view of the corner connector 102 with frames 104A-B according to the embodiments of the present disclosure. FIG. 9 shows an exploded view of the frame corner connection with frame bars 104A-B, the corner connector 102, and the screw 106. The frame bar 104A lies horizontally on the left, with a semi-circular notch 112A at its right end, and the frame bar 104B is positioned vertically on the right, with a matching semi-circular notch 112B at its top end, aligned to connect with the frame bar 104A. The corner connector 102 is shown between the frame bars 104A-B.

According to an embodiment of the present invention, a method of assembling a frame is provided. The method comprises providing the corner connector 102, aligning the notches 112A-B of frame bars 104A-B with the body of the corner connector 102, inserting the screw 106 into the central channel 108 of the corner connector 102, and tightening the screw 106 to cause expansion of the body and secure the frame bars 104A-B together at the corner.

The step of tightening the screw 106 includes using a driving tool to engage the head of the screw 106 and applying rotational force to tighten the screw 106 and expand the body of the corner connector 102 within the notches 112A-B of the frame bars 104A-B.

One of the principal advantages of the present invention is the ease of assembly and disassembly it provides. The corner connector 102 allows frame bars 104A-B corners to be joined together quickly without the need for extensive labor or specialized skills. This is particularly beneficial for individual consumers who may wish to frame artwork or photographs at home, as well as for professional framers looking to increase the efficiency of their assembly processes. The design of the corner connector 102 eliminates the need for permanent fastening methods, such as nails or glue, which can damage the frame materials and are not conducive to reusability.

Another significant advantage is the robustness of the joint created by the corner connector 102. Even though it allows for disassembly, the corner connector 102 does not sacrifice the stability and durability of the frame. The unique design of the expanding body ensures that once the corner connector 102 is tightened, it exerts even pressure at all joining points, creating a firm joint that resists loosening over time. This is essential not only for the longevity of the frame but also for the protection of the artwork it houses.

Furthermore, the corner connector's 102 design is aesthetically pleasing and can be made to blend seamlessly with a variety of frame styles. Unlike traditional fastening methods, which may leave visible holes or require additional covering, the corner connector 102 is designed to be inconspicuous once installed. This results in a clean and professional finish, enhancing the overall appearance of the framed piece.

The present invention also offers versatility in its application. The corner connector 102 is compatible with a wide range of frame sizes and profiles, making it suitable for various framing projects. This universality means that framers can maintain a smaller inventory of connectors to meet diverse framing requirements, simplifying stock management and potentially reducing costs.

Moreover, the corner connector's 102 ability to be disassembled facilitates more efficient storage and transport. Frames can be assembled on-site, reducing the risk of damage during transport and allowing for space-saving storage when not in use. For galleries, artists, and exhibitors who frequently transport frames to various locations, this can result in significant logistical and cost advantages.

The environmental impact of the corner connector 102 is another noteworthy benefit. By allowing for the reuse of frame components, the invention contributes to waste reduction. It aligns with sustainable practices by diminishing the need for new materials and reducing the frequency of frame replacement due to damage during assembly or disassembly.

In an alternative embodiment, the corner connector 102 for frames exhibits versatility by being adjustable in size. M ore particularly, the body of the corner connector 102 is adjustable in length, width, or diameter to accommodate frame bars of varying dimensions. This allows it to accommodate a variety of frame bar specifications, such as different lengths and widths, while maintaining structural stability. This flexibility is especially useful when the frame bars differ in size or shape, as the connector can adapt accordingly, ensuring a secure fit without compromising on strength. The adjustable feature also enables the connector to be used in various non-standard frames or custom designs, enhancing its applicability in different settings.

Beyond its use in frames, the corner connector 102 of the present invention can be applied to various other use cases involving the connection of any two components A and B together. These applications include, but are not limited to, decorative wooden TV frames, modular bookshelves, and other furniture or decorative items that require a sturdy and easily adjustable joint. The versatility of this corner connector 102 makes it an ideal solution for modular design systems where parts need to be frequently reconfigured or disassembled for storage or transportation.

To further enhance the connector's operational functionality, it can be constructed using various materials. In addition to plastics, metals, and composites, a steel plate material can be bent to match the shape of the connector, thereby increasing its durability in scenarios where heavy loads or frequent adjustments are expected. The present invention can also utilize natural wood materials for applications where aesthetic considerations are paramount or when a more organic look is desired. This flexibility in material choice ensures that the connector can be tailored to suit a wide range of operational scenarios and design preferences.

Overall, the present invention introduces a unique corner connector 102 for frames that significantly improves upon the limitations of traditional framing methods. Its ease of use, coupled with the strength and aesthetics it offers, positions it as an advantageous alternative for both casual and professional framing applications. The connector is easy to manufacture, has a low number of parts, and provides a secure and reliable connection.

Examples described herein can also be used in various other scenarios and for various purposes. It may be noted that the above-described examples of the present solution are for the purpose of illustration only. Although the solution has been described in conjunction with a specific embodiment thereof, numerous modifications may be possible without materially departing from the instructions and advantages of the subject matter described herein. Other substitutions, modifications, and changes may be made without departing from the spirit of the present solution. All of the features disclosed in this specification (including any accompanying claims, abstract, and drawings), and/or all of the steps of any method or process so disclosed, may be combined in any arrangement, except combinations where at least some of such features and/or steps are mutually exclusive.

The present description has been shown and described with reference to the foregoing examples. It is understood, however, that other forms, details, and examples can be made without departing from the spirit and scope of the present subject matter.

What is claimed is:

1. An expandable corner connector for joining first and second frame bars at a corner of a frame, the corner connector comprising:
a body comprising a first end and a second end;
a central channel extending longitudinally through the body from the first end to the second end, the central channel having an internal thread;
wherein the body is configured to be positioned within corresponding notches in the first and second frame bars;
a screw having a head and a threaded shaft, the threaded shaft configured to engage with the internal thread of the central channel;
wherein, upon insertion and tightening of the screw within the central channel, the body is configured to expand outward against the first and second frame bars, thereby securing the connection between the first and second frame bars.

2. The corner connector of claim 1, wherein the central channel is non-threaded, and expansion of the body is achieved by a self-tapping screw, compression, or frictional engagement.

3. The corner connector of claim 1, wherein the body is made of a material selected from the group consisting of plastics, metals, and composites.

4. The corner connector of claim 1, wherein the exterior surface of the body is textured to enhance frictional engagement with the first and second frame bars.

5. The corner connector of claim 1, wherein the exterior surface of the body is smooth.

6. The corner connector of claim 1, wherein the body further comprises a longitudinal slit extending from the central channel to the exterior surface.

7. The corner connector of claim 1, wherein the notches in the first and second frame bars are semi-circular.

8. The corner connector of claim 1, wherein the notches in the frame bars are of any complementary shape configured to receive the connector body and facilitate expansion-based locking.

9. The corner connector of claim 1, wherein the screw head is configured to engage with a driving tool to facilitate rotation and tightening of the screw.

10. The corner connector of claim 1, wherein the body is adjustable in length, width, or diameter to accommodate frame bars of varying dimensions.

11. A picture frame assembly comprising:
a first frame bar having a first notch;
a second frame bar having a second notch, wherein the first notch and the second notch are configured to align to form a corner; and
the corner connector of claim 1, positioned within the aligned first notch and second notch, and securing the first frame bar and the second frame bar together.

12. The picture frame assembly of claim 11, wherein the first frame bar and the second frame bar are made of a material selected from the group consisting of wood, metal, and composite materials.

13. A modular structure assembly, comprising:
a first and second components having corresponding notches or receptacles configured to align to form a corner; and
a corner connector for joining the first and second components at the corner, the corner connector comprising:
a body comprising a first end and a second end;
a central channel extending longitudinally through the body from the first end to the second end, the central channel having an internal thread;
wherein the body is configured to be positioned within the corresponding notches or receptacles in the first and second components;
a screw having a head and a threaded shaft, the threaded shaft configured to engage with the internal thread of the central channel;
wherein, upon insertion and tightening of the screw within the central channel, the body is configured to expand outward against the first and second components, thereby securing the connection between the first and second components.

14. The modular structure assembly of claim 13, wherein the central channel is non-threaded, and expansion of the body is achieved by a self-tapping screw, compression, or frictional engagement.
